(19) United States
(12) Patent Application Publication
(10) Pub. No.: US 2020/0160890 A1
(43) Pub. Date: May 21, 2020

(54) STORAGE CABINET

(71) Applicant: Jiangsu Fine Storage Information Technology Co., Ltd., Changshu City (CN)

(72) Inventors: Yilin LIU, Wuhan City (CN); Hui LUO, Changsha County (CN)

(73) Assignee: Jiangsu Fine Storage Information Technology Co., L td., Changshu City (CN)

(21) Appl. No.: 16/196,270

(22) Filed: Nov. 20, 2018

(51) Int. Cl. G11B 33/04; A47B 81/06; G06K 19/07

(52) U.S. Cl. CPC G11B 33/0461; G06K 19/0723; A47B 81/068

(57) ABSTRACT

A storage cabinet includes a cabinet body and is characterized in that at least one layer of storage unit is disposed in the cabinet body and is provided with sliding mechanisms capable of being pushed or pulled to move the storage unit forwards or backwards with respect to the cabinet body, and the storage units are installed layer by layer. The storage units and storage cabinet facilitate storage, taking and classification of a large batch of articles, reduce management cost and have a high degree of intelligence, thus, improving work efficiency.

### BACKGROUND OF THE INVENTION

### Field

The invention relates to a storage device, in particular to a storage cabinet.

### Background

It is hard to store and manage articles and particularly to store and manage a large batch of articles because convenient operation and efficient running can be ensured only if these articles can be conveniently stored, found and taken when used and can be classified without being confused or disordered. For instance, when a large batch of CDs storing various types of data and information are stored, the surfaces of the CDs need to keep clean; however, the CDs are likely to be stained and damaged and get lost purely through manual management, it is inconvenient to find out required CDs or to take the required CDs for use due to the fact that these CDs are prone to being confused, and consequentially, the efficiency is low, and the requirements in the big data era cannot be met.

### SUMMARY

To solve the technical problems mentioned above, the invention provides a storage cabinet to allow articles to be stored and taken conveniently.

The technical solution adopted by the invention to solve the technical problems is as follows:

A storage cabinet comprises a cabinet body, wherein at least one layer of storage unit is disposed in the cabinet body and is provided with sliding mechanisms capable of being pushed or pulled to move the storage unit forwards or backwards with respect to the cabinet body, and the storage units are installed layer by layer.

Preferably, each storage unit comprises a carrier provided with at least one tray used for storing articles. The sliding mechanisms are disposed on left sides and right sides of the carriers.

Preferably, each sliding mechanism comprises a sliding rail disposed on the corresponding carrier and a sliding rod sleeved with the sliding rail and having two ends fixed to the cabinet body. Obviously, the sliding mechanisms can be replaced with similar mechanisms, such as clamping groove sliding structures, capable of achieving forward or backward movement of the carriers.

Preferably, the travel distance of the sliding rods is twice the width of the carriers. When the carriers are installed layer by layer, the carrier on each layer can be pulled from one ends of the corresponding sliding rods to the other ends of the corresponding sliding rods without being blocked by the carrier on the upper layer, and thus, articles can be taken and placed without being affected.

Preferably, the number of the trays on each carrier is eight, and the eight trays are evenly arranged in two rows side by side to enable the carrier to be of a rectangular structure, so that the carrier has a sufficient supporting force while trays can be placed on the carrier as many as possible. This structure is an eight storage unit, which is called “eight unit” for short.

Preferably, a push-pull device is disposed in front of the trays on each carrier and is used for pulling or pushing the carrier to move.

Preferably, the push-pull devices are hook holders which are open leftwards or rightwards. When the carriers are installed layer by layer, hooks enter the hook holders via openings in left sides or right sides of the hook holders, and then the carrier on any layer can be conveniently pulled out. The hooks can be intelligently-controlled mechanical hooks.

Preferably, a first detection sensor and a second detection sensor are disposed on one side of the inner bottom surface of the cabinet body. The first detection sensor is used for detecting the stretching state of the storage units. The second detection sensor is used for detecting the restoring state of the storage units.

Preferably, a first reflector and a second reflector corresponding to the first detection sensor and the second detection sensor in position are disposed on the inner top surface of the cabinet body.

The detection operating principle of the sensors and the reflectors is as follows: when the carriers of the storage units are located at the rear ends of the sliding rods, the storage units are in the restoring state, at this moment, a laser signal transmitted from the second detection sensor to the second reflector will not be shielded by the carriers, and thus, whether or not the carriers are in the restoring state is effectively detected; and when the carriers of the storage units are located at the front ends of the sliding rods, the storage units are in the stretching state, at this moment, the laser signal transmitted from the first detection sensor to the first reflector is shielded by the carriers, and thus, whether or not the carriers are in the stretching state is effectively detected.

Preferably, an RFID reader is disposed on the back side of the cabinet body and is provided with tags attached to the carriers of the storage units on all the layers and a reader disposed at a position, corresponding to the tags, of a back door of the cabinet body. Articles in the storage units have different information data and respective serial numbers, the storage conditions, such as the remaining storage spaces and the types/serial numbers of articles, of the storage units can be checked by scanning and reading the tags of the storage units by the RFID reader so as to generate category information, then the basic storage condition of the storage cabinet is obtained, and data are transmitted to a main control system to be efficiently and intelligently managed in a unified mode and can be checked conveniently.

The invention has the following beneficial effects: the storage cabinet stores articles in the storage units, which can be densely distributed layer by layer and can form drawer structures capable of being pulled out through the sliding mechanisms, the storage capacity of the storage units depends on the size of the carriers and the number of the trays, and the storage capacity of the storage cabinet depends on the number of the storage units arrayed layer by layer; the storage cabinet can be reasonably designed and assembled according to actual requirements to facilitate storage, taking and classification of a large batch of articles, to reduce the management cost and to achieve a high degree of intelligence, thus, improving work efficiency.

### BRIEF DESCRIPTION OF THE FIGURES

FIG. 1 is a front view of a storage cabinet of the invention;

FIG. 2 is a schematic view of a storage unit of the invention; and

FIG. 3 is a back view of the storage cabinet of the invention.

Reference Signs: cabinet body 1; storage unit 2; sliding mechanism 201; sliding rail 2011; sliding rod 2012; carrier 202; tray 203; push-pull device 3; first detection sensor 4; second detection sensor 5; first reflector 6; second reflector 7; RFID reader 8; tag 801; reader 802.

### DETAILED DESCRIPTION

The invention is further described and expounded below with reference to the accompanying drawings and embodiments.

### Embodiment 1

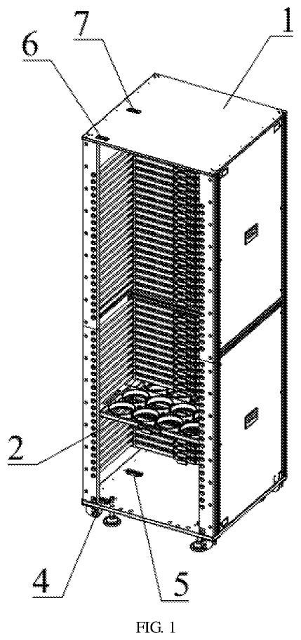

As shown in FIGS. 1-2, a storage cabinet comprises a cabinet body 1. At least one layer of storage unit 2 is disposed in the cabinet body 1 and is provided with sliding mechanisms 201 capable of being pushed or pulled to move the storage unit 2 forwards or backwards with respect to the cabinet body 1. The storage units 2 are installed layer by layer. In this embodiment, 44 layers of storage units are disposed in the cabinet body 1.

Each storage unit 2 comprises a carrier 202 provided with at least one tray 203 used for storing articles. The sliding mechanisms 201 are disposed on left sides and the right sides of the carrier 202.

Each sliding mechanism 201 comprises a sliding rail 2011 disposed on the corresponding carrier and a sliding rod 2012 sleeved with the sliding rail 2011 and having two ends fixed to the cabinet body 1. Obviously, the sliding mechanisms can be replaced with similar mechanisms, such as clamping groove sliding structures, capable of achieving forward or backward movement of the carriers.

The travel distance of the sliding rods 2012 is twice the width of the carriers 202. When the carriers are installed layer by layer, the carrier on each layer can be pulled from one ends of the corresponding sliding rods to the other ends of the corresponding sliding rods without being blocked by the carrier on the upper layer, and thus, articles can be taken and placed without being affected.

The number of the trays 203 on each carrier is eight, and the eight trays 203 are evenly arranged in two rows side by side to enable the carrier to be of a rectangular structure, so that the carrier has a sufficient supporting force while trays can be disposed on the carrier as many as possible. This structure is an eight storage unit, which is called “eight unit” for short.

A push-pull device 3 is disposed in front of the trays 203 on each carrier and is used for pushing or pulling the carrier to move.

In this embodiment, the push-pull devices 3 are hook holders which are open leftwards or rightwards. When the carriers are installed layer by layer, hooks enter the hook holders via openings in left sides or right sides of the hook holders, and then the carrier on any layer can be conveniently pulled out. The hooks can be intelligently-controlled mechanical hooks.

This embodiment has the following beneficial effects: articles are stored in the storage units, which can be densely arrayed layer by layer and can form drawer structures capable of being pulled out through the sliding mechanisms, the storage capacity of the storage units depends on the size of the carriers and the number of the trays, the storage capacity of the storage cabinet depends on the number of the storage units arrayed layer by layer, and the storage cabinet can be reasonably designed and assembled according to actual requirements to facilitate storage, taking and classification of a large batch of articles, to reduce the management cost and to achieve a high degree of intelligence, thus, improving work efficiency.

### Embodiment 2

As shown in FIGS. 1-2, on the basis of embodiment 1, a first detection sensor 4 and a second detection sensor 5 are disposed on one side of the inner bottom surface of the cabinet body 1. The first detection sensor 4 is used for detecting the stretching state of the storage units 2. The second detection sensor 5 is used for detecting the restoring state of the storage units 2.

A first reflector 6 and a second reflector 7 corresponding to the first detection sensor 4 and the second detection sensor 5 in position are disposed on the inner top surface of the cabinet body 1.

The first detection sensor and the second detection sensor are range finder sensors in the prior art, the first reflector and the second reflector are used for reflecting laser signals back and are also products in the prior art, and the detailed structure of the detection sensors and the reflectors will no longer be described herein.

Wherein, the mounting positions of the first detection sensor 4 and the second detection sensor 5 are determined in the following way: first, when the carriers 203 of the storage units 2 are located at the rear ends of the sliding rods 2012, the storage units 2 are in the restoring state, and at this moment, a laser signal transmitted from the second detection sensor 5 to the second reflector 7 should not be shielded by the carriers 203; second, when the carriers 203 of the storage units 2 are located at the front ends of the sliding rods 2012, the storage units 2 are in the stretching state, and at this moment, the laser signal transmitted from the first detection sensor 4 to the first reflector 6 should be shielded by the carriers 203.

The operating process under the normal condition is as follows: all the storage units are in the restoring state, the carrier of a specified storage unit is pulled out by the corresponding hook to be in the stretching state according to an instruction and is pushed back by the corresponding hook to be the restoring state according to another instruction after articles are stored in/taken out of the trays, and thus, one working process is completed.

The first detection sensor 4 and the first reflector 6 are mainly used for detecting the stretching state of the storage units 2, particularly: when the carriers 203 are pulled out by the hooks to be in the stretching state, a control system is considered normal if a laser signal emitted by the first detection sensor 4 is shielded and reflected back; and when the carriers 203 are pulled out, but are not in the stretching state, the control system is considered abnormal if the laser signal is reflected back by the first reflector 6 instead of being reflected after being shielded, and the abnormal storage unit can be accurately figured out.

The second detection sensor 5 and the second reflector 7 are mainly used for detecting the restoring state of the storage units 2, particularly: when the carriers 203 are pushed back by the hooks to be in the restoring state, the control system is considered normal if a laser signal emitted by the second detection sensor 5 is reflected back by the second reflector 7 instead of being shielded by the carriers 203; when the carriers 203 are pushed back, but are not in the restoring state, the control system is considered abnormal if the laser signal is shielded and reflected back, and the abnormal storage unit 2 can be accurately figured out according to the vertical distance detected between the second detection sensor 5 and the abnormal carrier 203.

This embodiment has the following beneficial effects: the working state of the storage units is effectively detected by the detection sensors to ensure normal operation of the storage cabinet, thus, facilitating inspection, monitoring and maintenance by workers and improving work efficiency.

### Embodiment 3

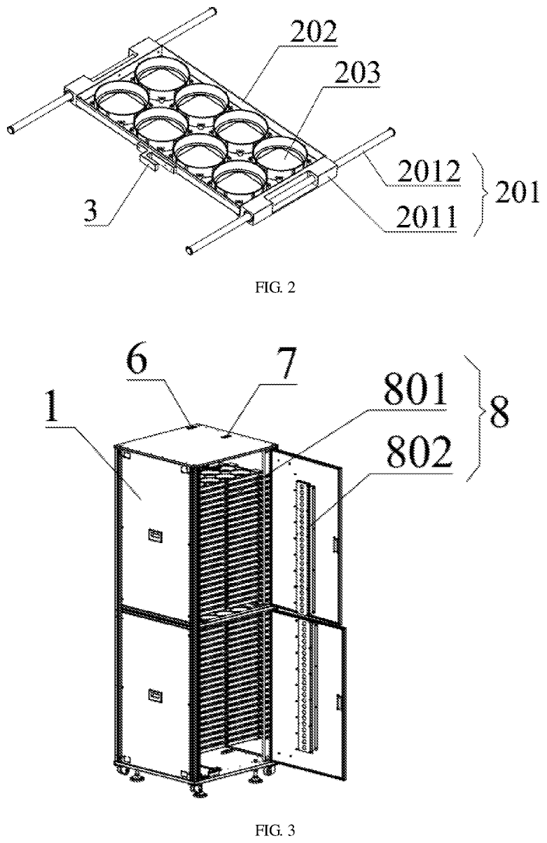

As shown in FIG. 3, on the basis of embodiment 1, a RFID reader 8 is disposed on the back side of the cabinet body 1 and is provided with tags 801 attached to the carriers 203 of the storage units 2 on all the layers and a reader 802 disposed at a position, corresponding to the tags 801, of a back door of the cabinet body 1. Articles stored in the storage units have different information data and respective serial numbers. The storage conditions, such as the remaining storage spaces and the types/numbers of articles, of the storage units can be checked by scanning and reading the tags attached to the storage units by the RFID reader so as to generate category information, then the basic storage condition of the storage cabinet is obtained, and data are transmitted to the main control system to be efficiently and intelligently managed in a unified manner and can be checked conveniently.

Under the enlightenment of the above ideal embodiments of the invention, various alterations and modifications can be made by those skilled in this field without deviating from the technological thought of the invention. The technical scope of the invention is by no means limited to the contents in the specification and should be defined in terms of the claims when necessary.

1. A storage cabinet, comprising;
a cabinet body, wherein at least one layer of storage unit is disposed in the cabinet body and is provided with sliding mechanisms capable of being pushed or pulled to move the storage unit forwards or backwards with respect to the cabinet body, and the storage units are installed layer by layer; and
a first detection sensor and a second detection sensor disposed on one side of an inner bottom surface of the cabinet body, the first detection sensor and the second detection sensor each comprising a distance sensor, wherein the first detection sensor is used for detecting a stretching state of the storage units, and the second detector is used for detecting a restoring state of the storage units.

2. The storage cabinet according to claim 1, wherein each said storage unit comprises a carrier provided with at least one tray used for storing articles, and the sliding mechanisms are disposed on left sides and right sides of the carriers.

3. The storage cabinet according to claim 2, wherein each said sliding mechanism comprises a sliding rail disposed on the corresponding carrier and a sliding rod sleeved with the sliding rail and having two ends fixed to the cabinet body.

4. The storage unit according to claim 3, wherein a travel distance of each said sliding rod is twice a width of the carriers.

5. The storage cabinet according to claim 2, wherein the number of trays on each said carrier is eight, and the eight trays on each said carrier are evenly arranged in two rows side by side.

6. The storage cabinet according to claim 2, wherein a push-pull device is disposed in front of the trays on each said carrier.

7. The storage cabinet according to claim 6, wherein each said push-pull device is a hook holder.

8. (canceled)

9. The storage cabinet according to claim 1, wherein a first reflector and a second reflector corresponding to the first detection sensor and the second detection sensor in position are disposed on an inner top surface of the cabinet body.

10. The storage cabinet according to claim 1, wherein an RFID reader is disposed on a back side of the cabinet body, wherein the storage cabinet is provide provided with tags attached to the carriers of the storage units on all layers and wherein the RFID reader is disposed at a position corresponding to the tags on a back door of the cabinet body.

11. The storage cabinet according to claim 1, wherein each said storage unit comprises a carrier provided with at least one tray used for storing articles, and wherein the second distance sensor is configured to determine a vertical distance between the second detection sensor and the at least one tray.
